(19) United States
(12) Patent Application Publication
(10) Pub. No.: US 2021/0363819 A1
(43) Pub. Date: Nov. 25, 2021

(54) ANGLED COUPLER FOR ROLLED MATERIAL

(71) Applicant: Draper, Inc., Spiceland, IN (US)

(72) Inventors: Rick A. Shopp, New Castle, IN (US); Jerry L. McPherson, JR., Charlottesville, IN (US)

(21) Appl. No.: 16/881,823

(22) Filed: May 22, 2020

(51) Int. Cl. E06B 9/42

(52) U.S. Cl. CPC E06B 9/42; E06B 2009/405

(57) ABSTRACT

The present disclosure relates to an angled coupler for coupling a first shaft of a first roller assembly to a second shaft of a second roller assembly. The angled coupler may comprise a surface coupling assembly. The surface coupling assembly may include a top bracket and at least one vertical bracket. The at least one vertical bracket may be pivotably coupled to the top bracket and pivotable about a first axis. The angled coupler may further include a roller coupling assembly coupled to the surface coupling assembly. The roller coupling assembly may include a drive assembly configured to be coupled to at least one of the first shaft of the first roller assembly and the second shaft of the first roller assembly. The at least one of the first shaft and the second shaft may be configured to be pivotable about a second axis relative to the drive assembly, the first axis and the second axis being co-axial.

### FIELD OF THE DISCLOSURE

The present disclosure relates to an angled coupler for rolled material and, more particularly, to an angled coupler for window coverings.

### BACKGROUND

Window coverings are typically provided to block ambient light from entering a room. Further, it is known to couple the window coverings of adjacent windows together so that a movement of one of the window coverings is coordinated with a movement of an adjacent window covering. In various instances, windows may be positioned at angles relative to one another, such that providing window coverings that are coupled together to these adjacent windows may prove to be difficult using existing couplers. As such, there is a need for a coupler configured to provide an improved ability for coupling adjacent window coverings for windows positioned at an angle relative to one another.

### SUMMARY

In an exemplary embodiment of the present disclosure, an angled coupler for coupling a first shaft of a first roller assembly to a second shaft of a second roller assembly is provided. The angled coupler comprising: a surface coupling assembly including a top bracket and at least one vertical bracket, the at least one vertical bracket pivotably coupled to the top bracket and pivotable about a first axis; and a roller coupling assembly coupled to the surface coupling assembly. The roller coupling assembly including a drive assembly configured to be coupled to at least one of the first shaft of the first roller assembly and the second shaft of the first roller assembly to communicate a rotation of one of the first roller assembly and the second roller assembly to the other of the first roller assembly and the second roller assembly. The at least one of the first shaft and the second shaft configured to be coupled to the drive assembly and pivotable about a second axis of the drive assembly, the first axis and the second axis being co-axial.

In an example thereof, the drive assembly includes at least one u-joint.

In another example thereof, the at least one vertical bracket includes a first vertical bracket and a second vertical bracket, the first vertical bracket being pivotably coupled to the top bracket and pivotable about the first axis and the second vertical bracket being pivotably coupled to the top bracket and pivotable about a third axis, and the drive assembly is configured to be coupled to both the first shaft and the second shaft, the first shaft configured to be coupled to the drive assembly and pivotable about the second axis relative to the drive assembly and the second shaft configured to be coupled to the drive assembly and pivotable about a fourth axis relative to the drive assembly, the third axis and the fourth axis being co-axial. In a variation thereof, the first shaft configured to be pivotable about a fifth axis relative to the drive assembly, the second axis being perpendicular to the fifth axis, and the second shaft configured to be pivotable about a sixth axis relative to the drive assembly, the fourth axis being perpendicular to the sixth axis.

In yet another example thereof, the roller coupling assembly further includes a support configured to couple the drive assembly to the surface coupling assembly, the support plate including a plurality of elongated vertical openings configured to allow the drive assembly to be adjustable relative to the support.

In another exemplary embodiment of the present disclosure, an angled coupler for coupling a first shaft of a first roller assembly to a second shaft of a second roller assembly is provided. The angled coupler comprising: a surface coupling assembly including a top bracket, the top bracket having a first vertical plane; and a roller coupling assembly coupled to the surface coupling assembly, the roller coupling assembly including a support plate, a vertical plane containing the support plate being co-planar with the first vertical plane of the top bracket.

In an example thereof, the first vertical plane is a central plane of the top bracket.

In another example thereof, the surface coupling assembly further includes a first vertical bracket coupled to the top bracket on a first side of the first vertical plane and a second vertical bracket coupled to the top bracket on a second side of the first vertical plane.

In a further example thereof, the roller coupling assembly further includes a drive assembly, a vertical plane of the drive assembly being co-planar with the first vertical plane of the top bracket. In a variation thereof, the vertical plane of the drive assembly is a central plane of the drive assembly.

In yet a further example thereof, the drive assembly includes a dual u-joint member, a bearing, and a guide plate, a plane containing at least a portion of the bearing, the guide plate, and the dual u-joint member being co-planar with the first vertical plane of the top bracket.

In a further exemplary embodiment of the present disclosure, an angled coupler for coupling a first shaft of a first roller assembly to a second shaft of a second roller assembly is provided. The angled coupler comprising: a surface coupling assembly; a support coupled to the surface coupling assembly, the support including a drive assembly which is adapted to support the first shaft of the first roller assembly and the second shaft of the second roller assembly; and a fascia supporting assembly removably coupled to the support in a plurality of different positions to allow adjustment of the fascia supporting assembly relative to the surface coupling assembly.

In an example thereof, the support includes at least one elongate horizontal opening.

In a variation thereof, the support includes at least one flange, the at least one elongate horizontal opening being positioned at least partially within the at least one flange. In a further variation thereof, the at least one elongate horizontal opening includes a first elongate horizontal opening and a second elongate horizontal opening. In still a further variation thereof, the fascia supporting assembly is rotatably coupled to the support. In yet a further variation thereof, the fascia supporting assembly includes a coupling bracket, a first vertical bracket pivotably coupled to the coupling bracket and a second vertical bracket pivotably coupled to the coupling bracket, the coupling bracket being coupled to the support.

In still another exemplary embodiment of the present disclosure, an angled coupler for coupling a first shaft of a first roller assembly to a second shaft of a second roller assembly is provided. The angled coupler comprising: a surface coupling assembly; a roller coupling assembly coupled to the surface coupling assembly; and a fascia supporting assembly coupled to the roller coupling assembly, wherein the fascia supporting assembly includes a coupling bracket coupled to the roller coupling assembly, a first vertical bracket, and a second vertical bracket, the first vertical bracket and the second vertical bracket each pivotable coupled to the coupling bracket, the first vertical bracket being adapted to support a first facia of the first roller assembly and the second vertical bracket being adapted to support a second facia of the second roller assembly.

In an example thereof, the coupling bracket includes a flanged vertical bracket, a first L-shaped bracket and a second L-shaped bracket, the flanged vertical bracket coupled to one of the first vertical bracket and the second vertical bracket, and the first and second L-shaped brackets coupled to the other of the first vertical bracket and the second vertical bracket. In a variation thereof, the first and second L-shaped brackets are coupled to the flanged vertical bracket.

In another example thereof, the roller coupling assembly includes a support plate, the first vertical bracket being coupled to the coupling bracket on a first side of a plane containing the support plate, and the second vertical bracket is coupled to the coupling bracket on a second side of the plane containing the support plate.

In a further example thereof, the surface coupling assembly includes a top bracket and at least one vertical bracket, the at least one vertical bracket pivotably coupled to the top bracket and pivotable about a first axis, and at least one of the first vertical bracket and the second vertical bracket of the fascia supporting assembly is pivotably coupled to the coupling bracket about a second axis, the first axis and the second axis being parallel. In a variation thereof, the roller coupling assembly includes a drive assembly which is adapted to support the first shaft of the first roller assembly and the second shaft of the second roller assembly such that at least one of the first shaft and the second shaft is pivotable about a third axis, the third axis being parallel to the first axis and the second axis. In a further variation thereof, the roller coupling assembly further includes a support plate, the first axis and the third axis being laterally spaced apart from the support plate by a first distance and the second axis being laterally spaced apart from the support plate by a second distance, the second distance being greater than the first distance.

In yet a further exemplary embodiment of the present disclosure, a method of coupling a first roller assembly rotatable about a first axis and a second roller assembly rotatable about a second axis is provided. The method comprising the steps of: providing a support assembly having a base, a first support rotatable relative to the base about a third axis and having a first mount surface adapted to abut a first environmental surface, and a second support rotatable relative to the base about a fourth axis and having a second mount surface adapted to abut a second environmental surface; rotating at least one of the first support relative to the base about the third axis and the second support relative to the base about the fourth axis to alter an angle formed by the first mount surface of the first support and the second mount surface of the second support; and supporting a drive assembly with the support assembly, the drive assembly including a first end adapted to be coupled to the first roller assembly, the first end being pivotable about a fifth axis coaxial with the third axis, and a second end adapted to be coupled to the second roller assembly, the second end being pivotable about a sixth axis coaxial with the fourth axis.

In an example thereof, the method further comprising coupling the support assembly to at least one of the first environmental surface and the second environmental surface.

In another example thereof, the method further comprising rotating the first roller assembly about the first axis resulting in the drive assembly rotating the second roller assembly about the second axis.

Additional features and advantages will become apparent to those skilled in the art upon consideration of the following detailed description.

### BRIEF DESCRIPTION OF THE DRAWINGS

Advantages and features of the embodiments of this disclosure will become more apparent from the following detailed description of exemplary embodiments when viewed in conjunction with the accompanying drawings, wherein:

FIG. 1 shows a front top left perspective view of a first embodiment of an angled coupler of the present disclosure having a first embodiment of a surface coupling assembly;

FIG. 2 shows a front bottom right perspective view of the angled coupler of FIG. 1;

FIG. 3 shows a front elevational view of the angled coupler of FIG. 1;

FIG. 4 shows a left side elevational view of the angled coupler of FIG. 1;

FIG. 5A shows a bottom plan view of the angled coupler of FIG. 1 coupled to a concave wall;

FIG. 5B shows a bottom plan view of the angled coupler of FIG. 1 having a second embodiment of a surface coupling assembly of the present disclosure coupled to a convex wall;

FIG. 6 shows a top perspective exploded view of the angled coupler of FIG. 1;

FIG. 7 shows a bottom perspective exploded view of the angled coupled of FIG. 1;

FIG. 8 shows a cross-sectional view of the angled coupler of FIG. 1 taken along line 8-8 of FIG. 3;

FIG. 9 shows front perspective view of a support plate and a u-joint assembly of the angled coupler of FIG. 1;

FIG. 10 shows a front top left perspective view of a second embodiment of an angled coupler of the present disclosure;

FIG. 11 shows a front bottom right perspective view of the angled coupler of FIG. 10;

FIG. 12 shows a partially exploded view of the angled coupler of FIG. 10 with a fascia supporting assembly shown exploded away from a roller coupling assembly and a surface coupling assembly of the angled coupler;

FIG. 13 shows a rear perspective view of the fascia supporting assembly of FIG. 12 and a support plate of the roller coupling assembly of FIG. 12;

FIG. 14 shows an exploded view of the fascia supporting assembly of FIG. 12; and

FIG. 15 shows a bottom plan view of the angled coupler of FIG. 10.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplifications set out herein illustrate embodiments of the disclosure, in one form, and such exemplifications are not to be construed as limiting the scope of the disclosure in any manner.

### DETAILED DESCRIPTION OF THE DRAWINGS

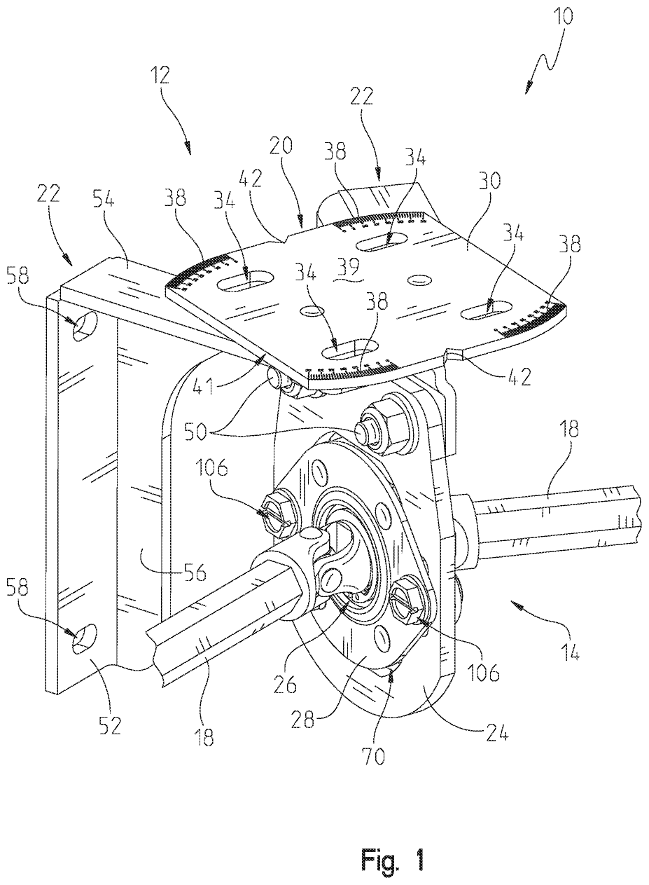

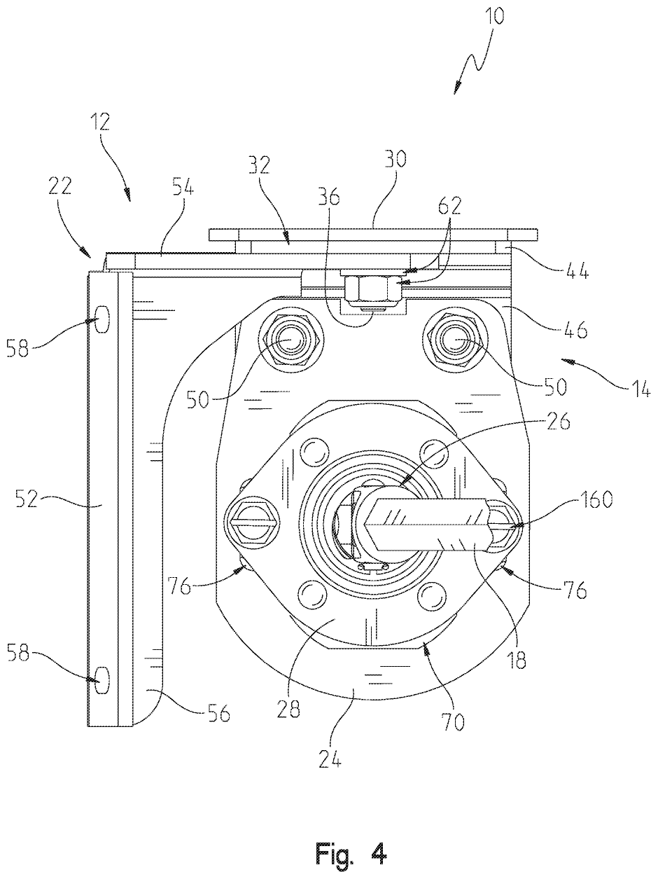

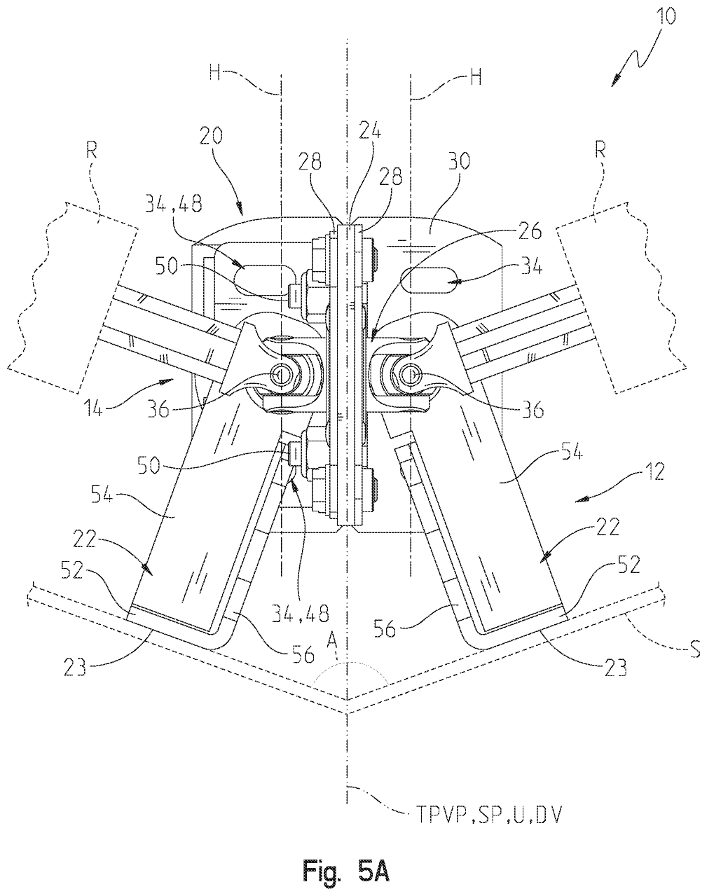

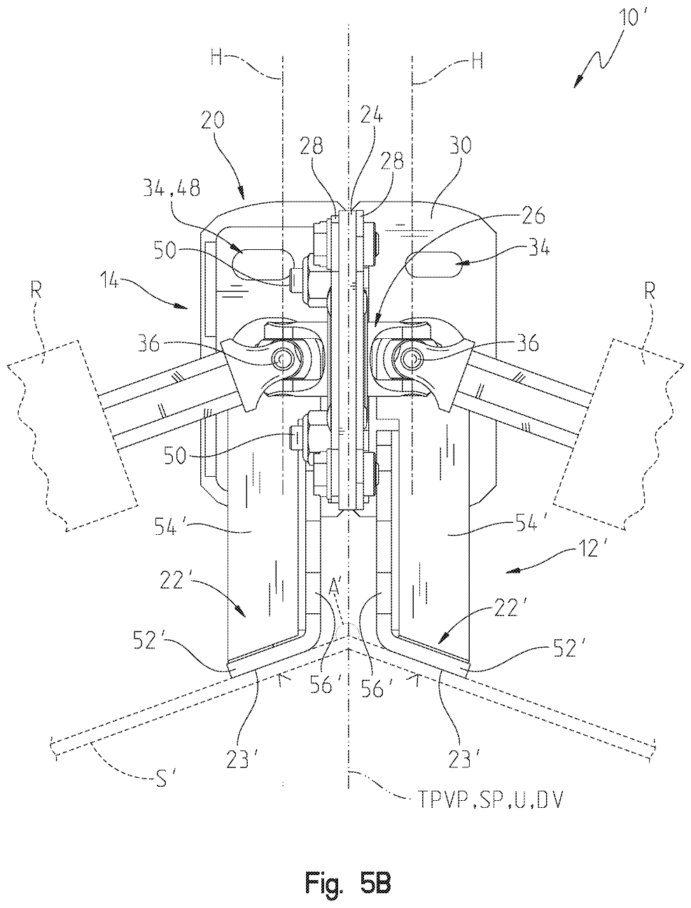

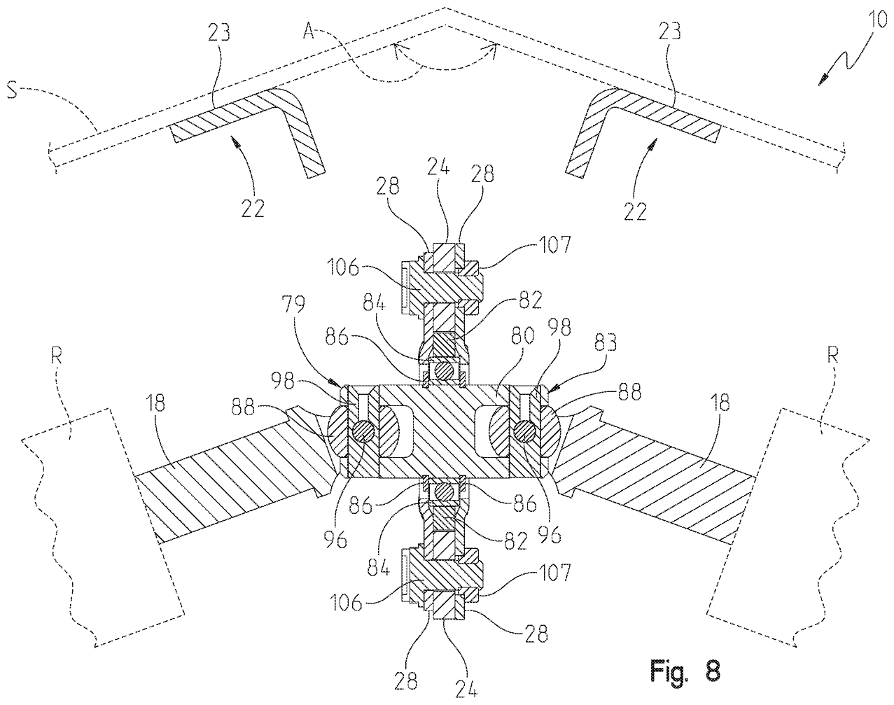

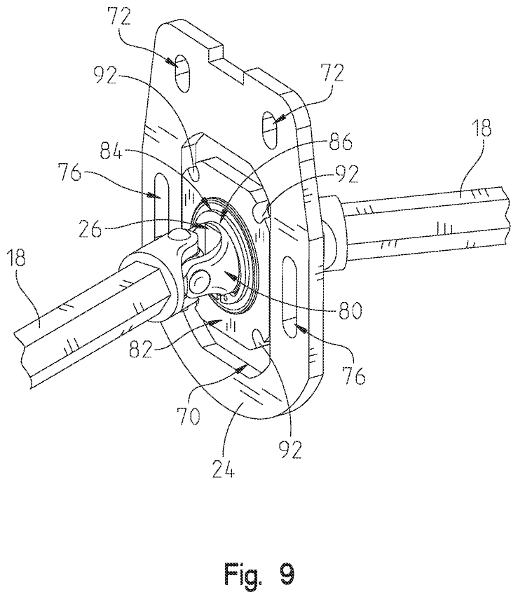

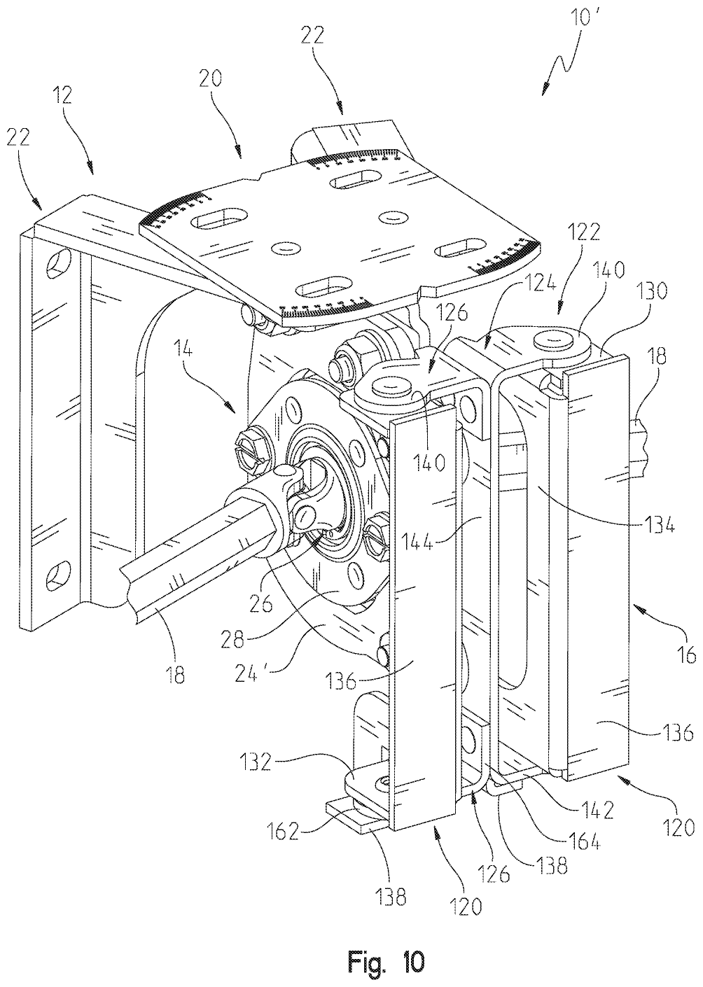

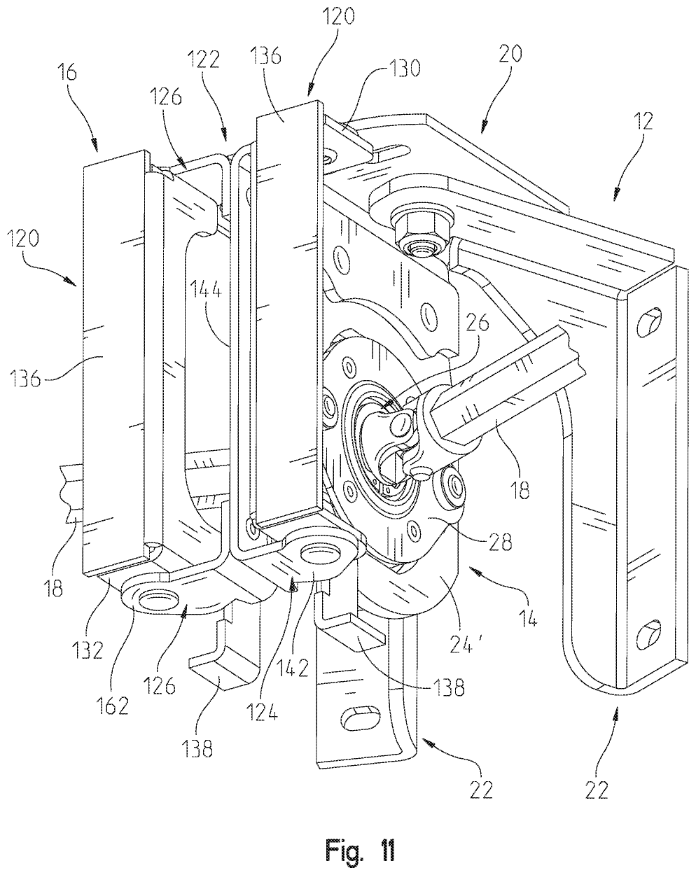

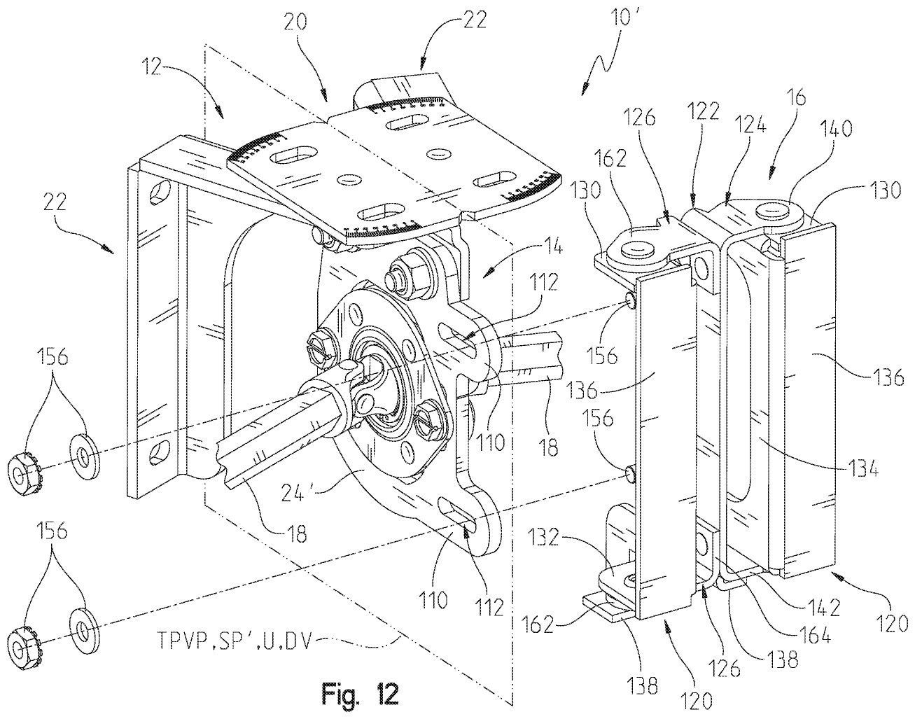

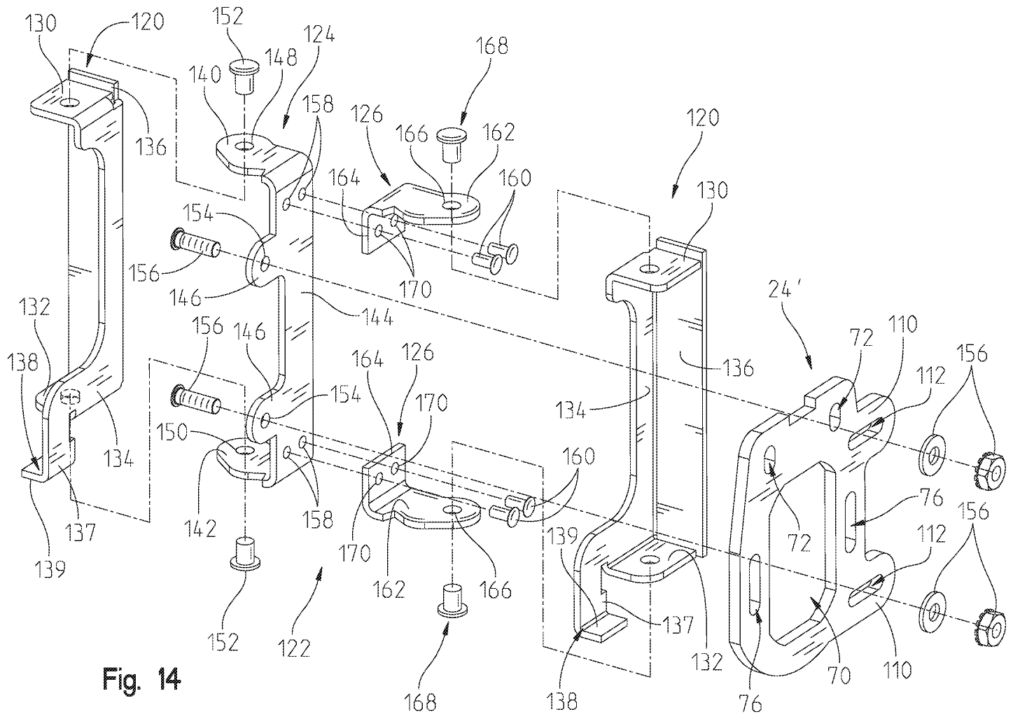

Referring to FIGS. 1-9, an angled coupler 10 for rolled material is provided including a surface coupling assembly 12, 12′ and a roller coupling assembly 14. In various embodiments, angled coupler 10 may further include a fascia supporting assembly 16, an embodiment discussed in detail below with reference to FIGS. 10-14. Angled coupler 10 is generally configured to couple shafts 18 of two separate roller assemblies R for rolled materials (FIG. 5). In various embodiments, shafts 18 may be inserts received within the roller assemblies R, while in other various embodiments, shafts 18 may each be a portion of one of the roller assemblies R.

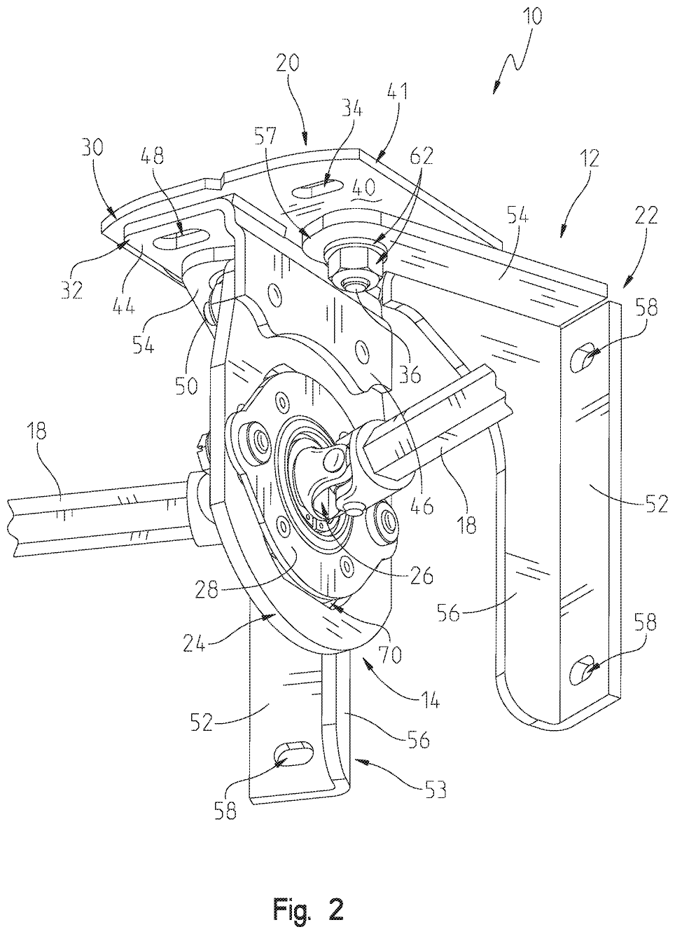

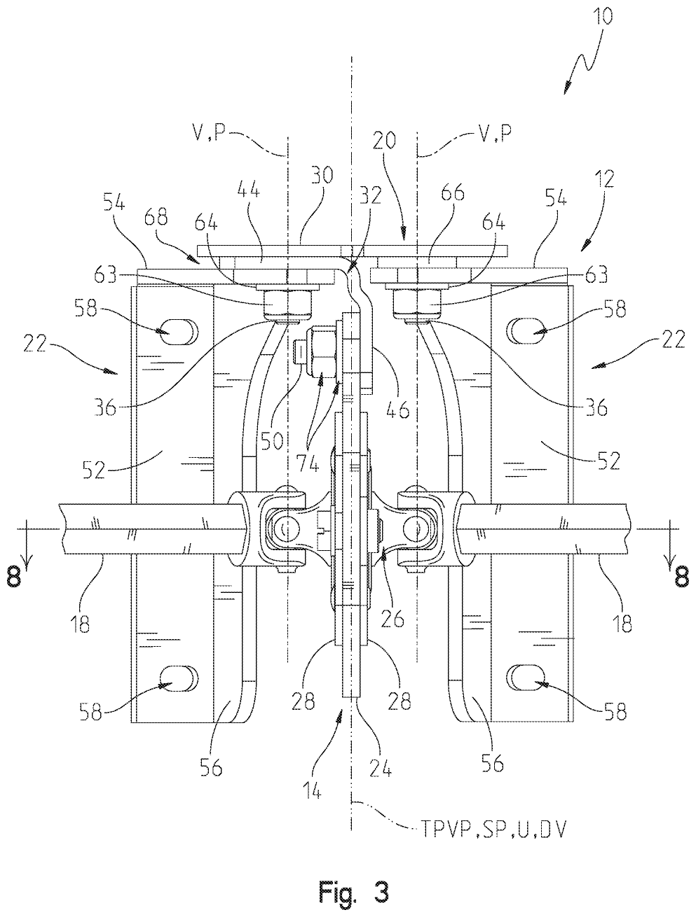

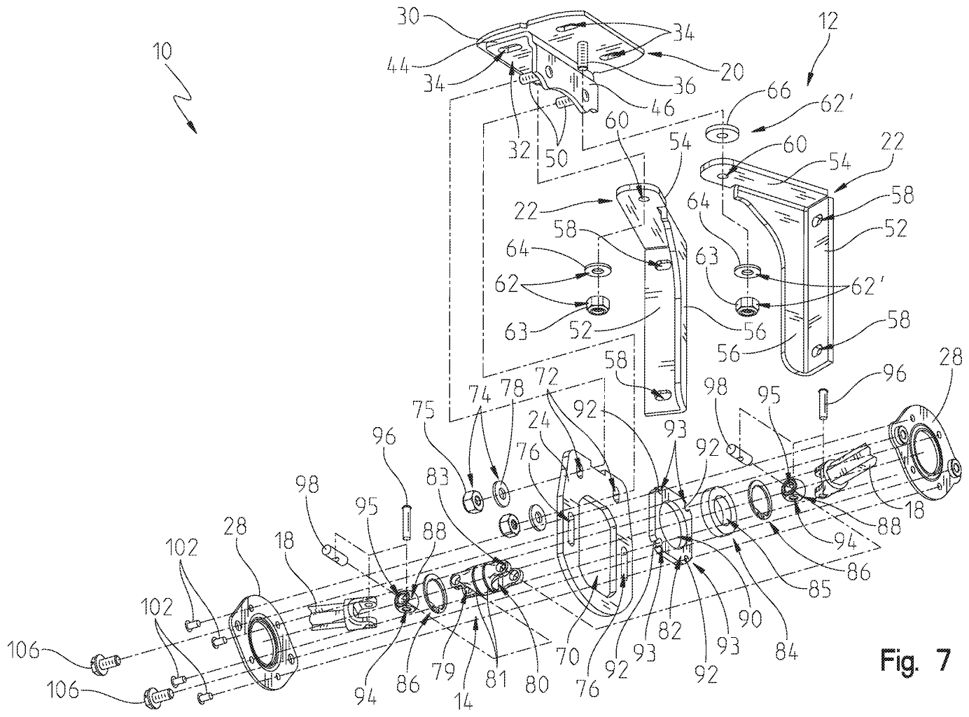

With reference to FIGS. 1-7, surface coupling assembly 12, 12′ is generally configured to couple roller coupling assembly 14 to at least one environmental surface (i.e., a ceiling, a wall, bulkhead, a frame, etc.) and generally includes a top bracket 20 and a pair of vertical brackets 22. Top bracket 20 of surface coupling assembly 12, 12′ generally includes a top plate 30 and an L-shaped bracket 32 (FIGS. 2 and 7). In the embodiments shown in FIGS. 1-14, top plate 30 and L-shaped bracket 32 are welded or otherwise coupled together to form a single, integral component. However, in other various embodiments, L-shaped bracket 32 may be removably coupled to top plate 30. Top plate 30 generally includes a plurality of openings 34 for coupling angled coupler 10 to a horizontal surface, and a pair of protrusions 36 (FIGS. 3, 5, and 7) positioned on separate sides of L-shaped bracket 32 configured to couple to vertical brackets 22. Top plate 30 includes a vertical plane TPVP, where one of vertical brackets 22 is coupled on a first or left side of vertical plane TPVP and the other of vertical brackets 22 is coupled on a second or right side of vertical plane TPVP. In various embodiments, top plate 30 may include a plurality of reference markings 38 on a top surface 39, a bottom surface 40 (FIG. 2), and/or a perimeter edge 41, and/or a pair of notches 42 indicating a center point of top plate 30 and positioned in plane TPVP. In various embodiments, plane TPVP is a central plane of top plate 30.

L-shaped bracket 32 generally includes a horizontal plate 44 and a vertical plate 46 (FIG. 2). Horizontal plate 44 is coupled to top plate 30, and includes a pair of openings 48 aligned with a pair of openings 34 of top plate 30. Vertical plate 46 is coupled to horizontal plate 44, and includes a pair of protrusions 50 configured to couple with roller coupling assembly 14. In various embodiments, horizontal plate 44 may be integrally formed with top plate 30 and/or vertical plate 46 may be integrally formed with horizontal plate 44.

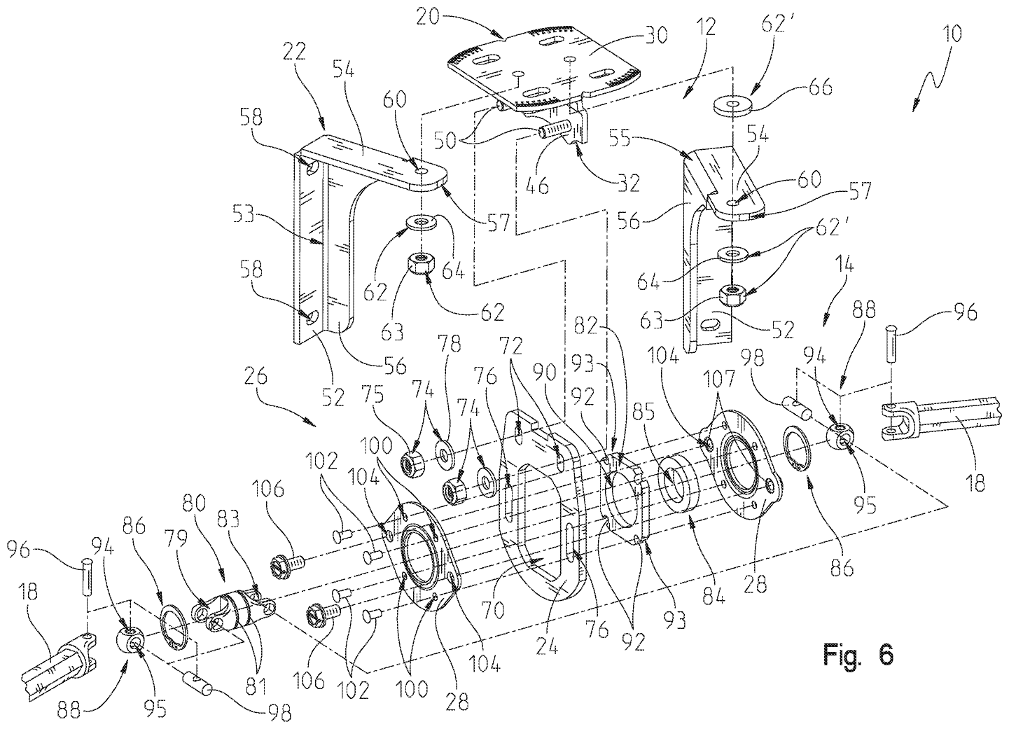

Still referring to FIGS. 1-7, vertical brackets 22, 22′ of surface coupling assembly 12, 12′ each generally include a vertical plate 52, 52′, a horizontal plate 54, 54′, and a coupling plate 56, 56′ integrally coupled at a first side 53 (FIG. 6) of vertical plate 52, 52′ and a first side 55 (FIG. 6) of horizontal plate 54, 54′. Vertical plate 52, 52′ generally includes two openings 58 for receiving fasteners (not shown) to couple angled coupler 10 to one or more vertical surface S, S′ (i.e., a wall, a frame, a window pane, etc.). Horizontal plate 54, 54′ generally includes an opening 60 (FIG. 6) configured to receive protrusion 36 therethrough for coupling vertical bracket 22, 22′ to top bracket 20 via a coupler 62 (i.e., a nut) received by protrusion 36 once passed through opening 60. In various embodiments, opening 60 may be positioned adjacent an outer end 57 of horizontal plate 54, 54′. Coupler 62 generally includes a nut 63 and a washer 64 for coupling vertical bracket 22, 22′ to top bracket 30. However, a coupler 62′ (FIG. 6) configured to couple the right side vertical bracket 22, 22′ to top bracket 30 may further include a washer 66 (FIGS. 3 and 6) positioned between top plate 30 of top bracket 20 and horizontal plate 54, 54′ of vertical bracket 22, 22′ to accommodate for a gap 68 (FIG. 3) created on the left side of surface coupling assembly 12, 12′ due to horizontal plate 44 of L-shaped bracket 32 of top bracket 20. Vertical brackets 22, 22′ are coupled to top bracket 20 in such a way that vertical brackets 22, 22′ are pivotable about an axis V (FIG. 3) to conform an angle A, A′ (see FIGS. 5A (concave surface S), 5B (convex surface S′), 8 and 15) formed by mounting surfaces 23, 23′ of vertical brackets 22, 22′ to match the angle of the surfaces S, S′ to which coupler 10 is attached. When surfaces S are concave relative to one another (FIG. 5A), vertical plate 52 and coupling plate 56 of surface coupling assembly 12 are at a substantially 90 degree angle relative to one another. When surfaces S′ are convex relative to one another (FIG. 5B), vertical plate 52′ and coupling plate 56′ of surface coupling assembly 12′ are at an obtuse angle relative to one another.

Referring now to FIGS. 1-8, roller coupling assembly 14 is generally configured to couple two rollers supporting rolled material for two separate openings and generally includes a support, a drive assembly configured to couple to shafts 18 of the two rollers, and a pair of securing members. In the illustrative embodiments shown in FIGS. 1-9, the support includes a support plate 24, the drive assembly includes a u-joint assembly 26, and the pair of securing members include securing plates 28. Support plate 24 extends vertically below top plate 30 such that a plane SP containing support plate 24 is co-planar with plane TPVP of top plate 30. In various embodiments, support plate 24 is vertically aligned with notches 42 of top plate 30 or a central point of top plate 30 such that plane SP containing support plate 24 is co-planar with vertical plane TPVP of top plate 30, when vertical plane TPVP is a central plane of top plate 30. Support plate 24 generally includes a central opening 70 (FIG. 6) configured to receive a portion of U-joint assembly 26, a pair of upper openings 72 (FIG. 6) configured for coupling support plate 24 to top bracket 20 via protrusions 50 on vertical plate 46 of L-shaped bracket 32 and couplers 74, and a pair of elongate vertical openings 76 for coupling securing plates 28 to support plate 24. Elongate vertical openings 76 allow for vertical adjustment of U-joint assembly 26 relative to support plate 24 and surface coupling assembly 12, 12′ to provide overall alignment of angled coupler 10. In various embodiments, coupler 74 includes a nut 75 and a washer 78.

With reference to FIGS. 1-9, u-joint assembly 26 generally includes a dual u-joint 80, a guide plate 82 configured to be positioned within central opening 70, a bearing 84 having a central opening 85, a pair of bearing clips 86 for securing bearing 84 relative to dual u-joint 80, and a pair of ball joints 88 for coupling u-joint assembly 26 to shafts 18. Dual u-joint 80 generally includes a first u-joint end 79 configured to couple with a first of shafts 18, a second u-joint end 83 configured to couple with a second of shafts 18, and a pair of notches 81 positioned between first u-joint end 79 and second u-joint end 83 configured to receive bearing clips 86 for securing bearing 84 relative to dual u-joint 80. Guide plate 82 generally includes a central opening 90 configured to receive and support bearing 84 and a plurality of notches 92 at each corner 93. Dual u-joint 80 generally extends through central opening 90 of guide plate 82 and central opening 85 of bearing 84. Ball joints 88 generally include a first opening 94 configured to receive a vertical bar 96 for coupling shaft 18 to u-joint assembly 26 and allowing shaft 18 to pivot and/or rotate about vertical axis P and a second opening 95 intersecting first opening 94 and configured to receive a horizontal bar 98 for coupling ball joint 88 to dual u-joint 80 and allowing shaft 18 to pivot and/or rotate about horizontal axis H, respectively, where vertical axis P is perpendicular to horizontal axis H.

In various embodiments, a vertical plane DV of dual u-joint 80 is co-planar with vertical plane TPVP of top bracket 20. In various embodiments, vertical plane DV of dual U-joint 90 is a central plane of dual U-joint 90. In addition, a plane U containing bearing 84, guide plate 82, and dual u-joint 80 is also co-planar with vertical plane TPVP of top bracket 20.

With reference to FIGS. 1-8, securing plates 28 are configured to secure u-joint assembly 26 to support plate 24. Securing plates 28 each include a plurality of openings 100 for receiving a plurality of couplers 102 received through notches 92 of guide plate 82 that secure u-joint assembly 26 to securing plates 28 and securing plates 28 to each other, and a pair of openings 104 for receiving a pair of couplers 106 that extend through elongate vertical openings 76 in support plate 24 and couple securing plates 28 to one another and u-joint assembly 26 to support plate 24. In various embodiments, one of securing plates 28 may include weld nuts 107 within openings 104 for receiving coupler 106 or openings 104 may be threaded. U-joint assembly 26 and securing plates 28 are coupled to support plate 24 such that vertical axis P of each ball joint 88 of dual u-joint 80 is co-axial with pivot axis V of the respective vertical bracket 22 on either side of support plate 24.

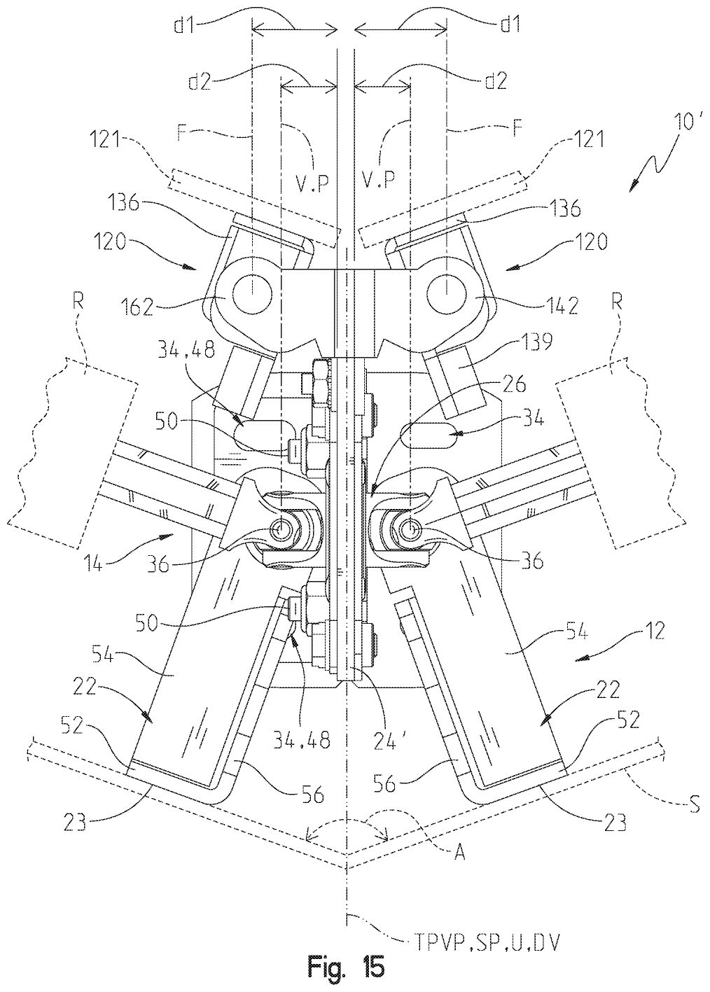

With reference to FIGS. 10-15, a second embodiment of angled coupler 10 (FIGS. 1-9) is shown as angled coupler 10′, with like reference numbers indicating like components with similar functionality and configuration to those of angled coupler 10 (FIGS. 1-9). In various embodiments, angled coupler 10 may include a support plate 24′ having flanges 110 and openings 112 for coupling roller coupling assembly 12, 12′ with fascia supporting assembly 16. Openings 112 are elongated in the horizontal direction such that fascia supporting assembly 16 may be coupled to support plate 24′ in a plurality of different positions within openings 112 to allow fascia supporting assembly 16 to be adjusted relative to roller coupling assembly 14 and/or surface coupling assembly 12, 12′ such that the fascia 121 (FIG. 15) remains parallel with shaft 18 and/or the roller assembly (not shown).

Fascia supporting assembly 16 generally includes a pair of fascia supporting brackets 120 for supporting fascia relative to each of the coupled roller assemblies and a coupling bracket 122 for coupling fascia supporting brackets 120 to each other and to support plate 24′. Fascia supporting brackets 120 are each pivotably coupled to coupling bracket 122 and each generally include a top horizontal flange 130, a bottom horizontal flange 132 opposite top flange 130, an interior plate 134 extending between and coupling top flange 130 to bottom flange 132, and a front plate 136 extend from just above top flange 130 to just below bottom flange 132. In various embodiments, top horizontal flange 130, bottom horizontal flange 132, interior plate 134, and front plate 136 are all a single, integral component, however, in various embodiments, one or more of top horizontal flange 130, bottom horizontal flange 132, interior plate 134, and front plate 136 may be removably coupled to the other of top horizontal flange 130, bottom horizontal flange 132, interior plate 134, and front plate 136. Furthermore, in various embodiments, interior plate 134 may include a flange 138 extending below bottom horizontal flange 132. Flange 138 may include a vertical portion 137 and a horizontal portion 139 extending from vertical portion 137.

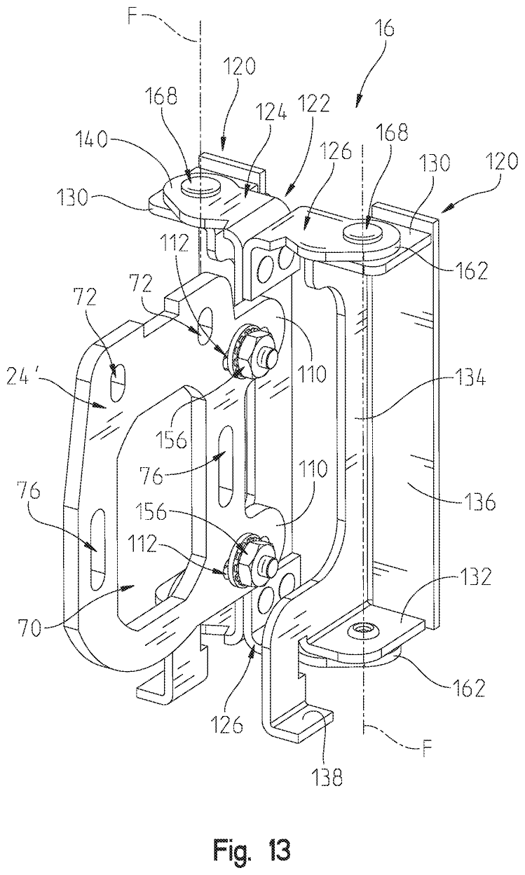

Still referring to FIGS. 10-15, coupling bracket 122 includes vertical bracket 124 and a pair of a L-shaped brackets 126. In the embodiment shown in FIGS. 10-14, L-shaped brackets 126 and vertical bracket 124 are separate components, however, in various embodiments, vertical bracket 124 and L-shaped brackets 126 may be formed of a single, unitary component. Vertical bracket 124 generally includes a top horizontal flange 140, a bottom horizontal flange 142 opposite top horizontal flange 140, a body plate 144 extending between top horizontal flange 140 and bottom horizontal flange 142, and a pair of vertical flanges 146 extending inward towards roller coupling assembly 14. Top horizontal flange 140 and bottom horizontal flange 142 each include an opening 148, 150, respectively, configured to receive couplers 152 for coupling coupling bracket 122 to top horizontal flange 130 and bottom horizontal flange 132 of one of fascia supporting brackets 120, respectively. Vertical flanges 146 each include an opening 154 configured to receive a coupler 156 for coupling coupling bracket 122 to elongate openings 112 of support plate 24′. Body plate 144 includes at least one opening 158, illustratively two, configured for receiving couplers 160 for coupling L-shaped brackets 126 to vertical bracket 124, when vertical bracket 124 and L-shaped brackets 126 are separate components. L-shaped brackets 126 each generally include a horizontal flange 162 and a vertical flange 164 integrally formed in the shape of an “L”. Horizontal flanges 162 include openings 166 for receiving couplers 168 for coupling coupling bracket 122 to the other of fascia supporting brackets 120. Vertical flanges 164 of L-shaped brackets 126 include at least one opening 170, illustratively two, for coupling L-shaped brackets 126 to openings 158 of body plate 144 of vertical bracket 124. Couplers 152 and 168 configured to couple coupling bracket 122 to fascia supporting brackets 120 are also configured such that fascia supporting brackets 120 and the fascia 121 supported therefrom (FIG. 15) are pivotable about axis F (FIG. 13) relative to coupling bracket 122 and the remainder of angled coupler 10, 10′ including surface coupling assembly 12, 12′ and roller coupling assembly 14. In various embodiments, axis F of fascia supporting assembly 16 may be parallel to axis V of surface coupling assembly 12, 12′ and/or vertical axis P of u-joint assembly 26. Furthermore, in various embodiments, axis F of fascia supporting assembly 16 may be laterally spaced apart from support plate 24′ by a distance d₁ that is greater than a lateral distance d2 between support plate 24′ and axis V of surface coupling assembly 12, 12′ and/or vertical axis P of u-joint assembly 26. A first of fascia supporting brackets 120 is generally coupled to coupling bracket 122 on a first side of plane SP′ of support plate 24′, and the other fascia supporting bracket 120 is coupled to coupling bracket 122 on a second side of plane SP′ of support plate 24′.

For installation of angled coupler 10, 10′, top bracket 20 and vertical bracket 22 of surface coupling assembly 12, 12′ are first installed to the desired surfaces by rotating vertical brackets 22 relative to top bracket 20 such that angle A between mounting surfaces 23 of vertical brackets 22 matches an angle between the two environmental surfaces S to which they are installed, and coupling vertical brackets 22 to the respective environmental surfaces S. Once surface coupling assembly 12, 12′ is properly installed, roller coupling assembly 14 and/or fascia supporting assembly 16 are then coupled to surface coupling assembly 12, 12′ such that rotation of one of the two roller assemblies results in rotations of the other roller assembly. These steps allow for easier installation of angled coupler 10, 10′ and the rollers supporting the rolled material.

While various embodiments of the disclosure have been shown and described, it is understood that these embodiments are not limited thereto. The embodiments may be changed, modified and further applied by those skilled in the art. Therefore, these embodiments are not limited to the detail shown and described previously, but also include all such changes and modifications.

What is claimed is:

1. An angled coupler for coupling a first shaft of a first roller assembly to a second shaft of a second roller assembly, the angled coupler comprising:
a surface coupling assembly including a top bracket and at least one vertical bracket, the at least one vertical bracket pivotably coupled to the top bracket and pivotable about a first axis; and
a roller coupling assembly coupled to the surface coupling assembly, the roller coupling assembly including a drive assembly configured to be coupled to at least one of the first shaft of the first roller assembly and the second shaft of the first roller assembly to communicate a rotation of one of the first roller assembly and the second roller assembly to the other of the first roller assembly and the second roller assembly, the at least one of the first shaft and the second shaft configured to be coupled to the drive assembly and pivotable about a second axis of the drive assembly, the first axis and the second axis being co-axial.

2. The angled coupler of claim 1, wherein the drive assembly includes at least one u-joint.

3. The angled coupler of claim 1, wherein the at least one vertical bracket includes a first vertical bracket and a second vertical bracket, the first vertical bracket being pivotably coupled to the top bracket and pivotable about the first axis and the second vertical bracket being pivotably coupled to the top bracket and pivotable about a third axis, and the drive assembly is configured to be coupled to both the first shaft and the second shaft, the first shaft configured to be coupled to the drive assembly and pivotable about the second axis relative to the drive assembly and the second shaft configured to be coupled to the drive assembly and pivotable about a fourth axis relative to the drive assembly, the third axis and the fourth axis being co-axial.

4. The angled coupler of claim 3, wherein the first shaft configured to be pivotable about a fifth axis relative to the drive assembly, the second axis being perpendicular to the fifth axis, and the second shaft configured to be pivotable about a sixth axis relative to the drive assembly, the fourth axis being perpendicular to the sixth axis.

5. The angled coupler of claim 1, wherein the roller coupling assembly further includes a support configured to couple the drive assembly to the surface coupling assembly, the support plate including a plurality of elongated vertical openings configured to allow the drive assembly to be adjustable relative to the support.

6. An angled coupler for coupling a first shaft of a first roller assembly to a second shaft of a second roller assembly, the angled coupler comprising:
a surface coupling assembly including a top bracket, the top bracket having a first vertical plane; and
a roller coupling assembly coupled to the surface coupling assembly, the roller coupling assembly including a support plate, a vertical plane containing the support plate being co-planar with the first vertical plane of the top bracket.

7. The angled coupler of claim 6, wherein the first vertical plane is a central plane of the top bracket.

8. The angled coupler of claim 6, wherein the surface coupling assembly further includes a first vertical bracket coupled to the top bracket on a first side of the first vertical plane and a second vertical bracket coupled to the top bracket on a second side of the first vertical plane.

9. The angled coupler of claim 6, wherein the roller coupling assembly further includes a drive assembly, a vertical plane of the drive assembly being co-planar with the first vertical plane of the top bracket.

10. The angled coupler of claim 9, wherein the vertical plane of the drive assembly is a central plane of the drive assembly.

11. The angled coupler of claim 6, wherein the drive assembly includes a dual u-joint member, a bearing, and a guide plate, a plane containing at least a portion of the bearing, the guide plate, and the dual u-joint member being co-planar with the first vertical plane of the top bracket.

12. An angled coupler for coupling a first shaft of a first roller assembly to a second shaft of a second roller assembly, the angled coupler comprising:
a surface coupling assembly;
a support coupled to the surface coupling assembly, the support including a drive assembly which is adapted to support the first shaft of the first roller assembly and the second shaft of the second roller assembly; and
a fascia supporting assembly removably coupled to the support in a plurality of different positions to allow adjustment of the fascia supporting assembly relative to the surface coupling assembly.

13. The angled coupler of claim 12, wherein the support includes at least one elongate horizontal opening.

14. The angled coupler of claim 13, wherein the support includes at least one flange, the at least one elongate horizontal opening being positioned at least partially within the at least one flange.

15. The angled coupler of claim 13, wherein the at least one elongate horizontal opening includes a first elongate horizontal opening and a second elongate horizontal opening.

16. The angled coupler of claim 12, wherein the fascia supporting assembly is rotatably coupled to the support.

17. The angled coupler of claim 16, wherein the fascia supporting assembly includes a coupling bracket, a first vertical bracket pivotably coupled to the coupling bracket and a second vertical bracket pivotably coupled to the coupling bracket, the coupling bracket being coupled to the support.

18. An angled coupler for coupling a first shaft of a first roller assembly to a second shaft of a second roller assembly, the angled coupler comprising:
a surface coupling assembly;
a roller coupling assembly coupled to the surface coupling assembly; and
a fascia supporting assembly coupled to the roller coupling assembly, wherein the fascia supporting assembly includes a coupling bracket coupled to the roller coupling assembly, a first vertical bracket, and a second vertical bracket, the first vertical bracket and the second vertical bracket each pivotable coupled to the coupling bracket, the first vertical bracket being adapted to support a first facia of the first roller assembly and the second vertical bracket being adapted to support a second facia of the second roller assembly.

19. The angled coupler of claim 18, wherein the coupling bracket includes a flanged vertical bracket, a first L-shaped bracket and a second L-shaped bracket, the flanged vertical bracket coupled to one of the first vertical bracket and the second vertical bracket, and the first and second L-shaped brackets coupled to the other of the first vertical bracket and the second vertical bracket.

20. The angled coupler of claim 19, wherein the first and second L-shaped brackets are coupled to the flanged vertical bracket.

21. The angled coupler of claim 18, wherein the roller coupling assembly includes a support plate, the first vertical bracket being coupled to the coupling bracket on a first side of a plane containing the support plate, and the second vertical bracket is coupled to the coupling bracket on a second side of the plane containing the support plate.

22. The angled coupler of claim 18, wherein the surface coupling assembly includes a top bracket and at least one vertical bracket, the at least one vertical bracket pivotably coupled to the top bracket and pivotable about a first axis, and at least one of the first vertical bracket and the second vertical bracket of the fascia supporting assembly is pivotably coupled to the coupling bracket about a second axis, the first axis and the second axis being parallel.

23. The angled coupler of claim 22, wherein the roller coupling assembly includes a drive assembly which is adapted to support the first shaft of the first roller assembly and the second shaft of the second roller assembly such that at least one of the first shaft and the second shaft is pivotable about a third axis, the third axis being parallel to the first axis and the second axis.

24. The angled coupler of claim 23, wherein the roller coupling assembly further includes a support plate, the first axis and the third axis being laterally spaced apart from the support plate by a first distance and the second axis being laterally spaced apart from the support plate by a second distance, the second distance being greater than the first distance.

25. A method of coupling a first roller assembly rotatable about a first axis and a second roller assembly rotatable about a second axis, the method comprising the steps of:
providing a support assembly having a base, a first support rotatable relative to the base about a third axis and having a first mount surface adapted to abut a first environmental surface, and a second support rotatable relative to the base about a fourth axis and having a second mount surface adapted to abut a second environmental surface;
rotating at least one of the first support relative to the base about the third axis and the second support relative to the base about the fourth axis to alter an angle formed by the first mount surface of the first support and the second mount surface of the second support; and
supporting a drive assembly with the support assembly, the drive assembly including a first end adapted to be coupled to the first roller assembly, the first end being pivotable about a fifth axis coaxial with the third axis, and a second end adapted to be coupled to the second roller assembly, the second end being pivotable about a sixth axis coaxial with the fourth axis.

26. The method of claim 25, further comprising coupling the support assembly to at least one of the first environmental surface and the second environmental surface.

27. The method of claim 25, further comprising rotating the first roller assembly about the first axis resulting in the drive assembly rotating the second roller assembly about the second axis.
